(19) United States
(12) Patent Application Publication
(10) Pub. No.: US 2009/0054100 A1
(43) Pub. Date: Feb. 26, 2009

(54) Television broadcast reception device, television broadcast reception device control method, and television broadcast reception device power consumption management method

(76) Inventor: Hideo Ishida, Hyogo (JP)

Correspondence Address: MCDERMOTT WILL & EMERY LLP, 600 13TH STREET, NW, WASHINGTON, DC, 20005-3096, US

(21) Appl. No.: 11/662,587

(22) PCT Filed: Apr. 28, 2006
(86) PCT No.: PCT/JP2006/308961

§ 371 Date: Mar. 13, 2007

(30) Foreign Application Priority Data
Jun. 2, 2005 (JP) 2005-162411

(51) Int. Cl. H04M 1/00; H04N 5/445

(52) U.S. Cl. 455/556.1; 725/39; 455/574

(57) ABSTRACT

Based on the program information for programs to be viewed that have been set by the user in a program-to-view setting section 105, a viewing duration calculating section 106 calculates the total viewing duration for programs to be viewed. A power consumption calculating section 107 calculates the amount of power to be consumed based on the total viewing duration. A battery level detection section 109 detects the battery level. When the battery level is less than the amount of power to be consumed, a recharge notification section 110 notifies the user that the battery needs to be recharged.

### TECHNICAL FIELD

The present invention relates to a battery-powered television broadcast reception device built in a mobile device such as a portable television or a mobile telephone, a device for controlling the television broadcast reception device, and a power management method for the television broadcast reception device.

### BACKGROUND ART

There is a plan to launch terrestrial digital broadcasting for mobile terminals such as portable televisions and mobile telephones. There is a plan for the terrestrial digital broadcasting for mobile terminals to use H264 as a data compression format for compressing video data and audio data (hereinafter video data and audio data are referred to collectively as “audio video data”).

The process of decoding audio video data, which has been compressed by a compression format such as H264, is a heavy load on a portable television, for example, and consumes a large amount of power. Therefore, the battery may run down inadvertently while the user is viewing a TV program. Particularly, with the digital camera function, the audio player function and the television receiver function added to their original functions, i.e., the telephone function and the email function, mobile telephones undergo a significant increase in the power consumption. It is expected that the battery can often run down inadvertently while the user is talking or viewing TV on the mobile telephone.

Information processing devices, e.g., notebook-type personal computers, address such an increase in the power consumption as follows. That is, each of the functions of an information processing device is assigned a degree of priority, wherein when the battery level goes low, functions of lower degrees of priority are shut down so that only those functions of higher degrees of priority are powered, thus reducing the total power consumption (see, for example, Patent Document 1). Thus, the amount of power consumed is controlled so that data can be processed over a longer period of time.

In a digital broadcast receiving system, when the battery level goes low, the system records the program being viewed on a recording medium while shutting down the power supply to audio video data reproducing means and display means, which consume large amounts of power, thus reducing the total power consumption (see, for example, Patent Document 2).

Patent Document 1: Japanese Laid-Open Patent Publication No. 2001-331242

Patent Document 2: Japanese Laid-Open Patent Publication No. 2003-283958

### DISCLOSURE OF THE INVENTION

### Problems to be Solved by the Invention

However, where some of the functions with lower degrees of priority are shut down, the battery can still run down inadvertently while data is being processed, thus failing to guarantee the operation of the information processing device to the end.

Where a program being viewed is recorded on a recording medium, the battery can still run down inadvertently before the end of the program, thus failing to guarantee that the program is recorded to the end.

The present invention has been made in view of the problems set forth above, and has an object to provide a battery-powered television broadcast reception device, in which it is possible to prevent the battery from running down inadvertently while a program is being viewed.

### Means for Solving the Problems

In order to achieve the object set forth above, a first aspect of the present invention is directed to a battery-powered television broadcast reception device, comprising:

a signal receiving section for receiving a television broadcasting signal;

a reproduction section for decoding and reproducing video data and audio data of a program included in the television broadcasting signal received by the signal receiving section;

a program-to-view setting section in which a plurality of program information are set, each program information including a starting time and a finishing time of a program to be viewed;

a viewing duration calculating section for calculating a viewing duration for each program information set in the program-to-view setting section by subtracting the starting time from the finishing time, and also calculating a total viewing duration by adding together the viewing durations of all program information set in the program-to-view setting section;

a power consumption calculating section for calculating a total amount of power to be consumed by the signal receiving section and the reproduction section operating over a period of the total viewing duration;

a battery level detection section for detecting a battery level of the battery; and

a recharge notification section for notifying a user that the battery needs to be recharged when the total amount of power to be consumed is greater than the battery level detected by the battery level detection section.

Thus, when the battery level is not high enough for viewing a program, the user is notified in advance that the battery needs to be recharged, thereby realizing a battery-powered television broadcast reception device in which it is possible to prevent a situation where the battery runs down inadvertently while viewing a program.

A second aspect of the present invention is directed to the television broadcast reception device of the first aspect, wherein:

the television broadcasting signal is a signal including program information indicating a starting time and a finishing time of a program; and

the program-to-view setting section displays a list of the program information, and selected ones of the displayed program information are set in the program-to-view setting section.

Thus, the user can more easily set programs to view.

A third aspect of the present invention is directed to the television broadcast reception device of the second aspect, wherein:

the program information further includes information indicating a length of extension of each program; and

the viewing duration calculating section further adds the length of extension to a total of the viewing durations of all program information set in the program-to-view setting section to thereby obtain the total viewing duration.

Thus, the length of extension of each program is added to the total viewing duration. Therefore, it is possible to prevent a situation where the battery runs down inadvertently while viewing a program, even when viewing a program that may possibly be extended to a later finishing time, such as live coverage of a sporting event.

A fourth aspect of the present invention is directed to the television broadcast reception device of the first aspect, wherein:

the viewing duration calculating section calculates, for each program information set in the program-to-view setting section, an accumulative viewing duration by adding together the viewing duration of the subject program information and that of program information for a program whose starting time is earlier than that of the subject program information;

the power consumption calculating section calculates, as the total amount of power to be consumed, an amount of power to be consumed by the signal receiving section and the reproduction section operating over a period of the accumulative viewing duration; and

the recharge notification section notifies that programs cannot be viewed when the total amount of power to be consumed is greater than the battery level detected by the battery level detection section.

Thus, the accumulative viewing duration is calculated for each selected program. Therefore, the user can identify which program or programs can be viewed with the current battery level. Thus, if it is not possible to view all of the selected programs due to a low battery level, the user can re-select programs by narrowing down the list of programs to view.

A fifth aspect of the present invention is directed to the television broadcast reception device of the first aspect, further including a mobile telephone section powered by the battery, wherein the power consumption calculating section calculates, as the total amount of power to be consumed, a sum of an amount of power to be consumed by the signal receiving section and the reproduction section operating over a period of the total viewing duration and an amount of power to be consumed by the mobile telephone section operating in a stand-by mode from a present point in time until the finishing time of the program information for a program to be viewed set in the program-to-view setting section.

Thus, even if the television broadcast reception device of the present invention is provided in a mobile telephone, for example, it is possible to prevent a situation where the battery runs down inadvertently while viewing a program.

A sixth aspect of the present invention is directed to the television broadcast reception device of the first aspect, further including:

a timer section for keeping a current time; and

a time setting section for setting time information representing a point in time specified by the user, wherein:

the power consumption calculating section calculates the total amount of power to be consumed when the current time kept by the timer section coincides with the time information set in the time setting section; and

the recharge notification section makes the notification when the current time kept by the timer section coincides with the time information set in the time setting section.

A seventh aspect of the present invention is directed to the television broadcast reception device of the first aspect, further including:

a position information detection section for detecting current position information; and

a location information setting section for setting position information representing a position specified by the user, wherein:

the power consumption calculating section calculates the total amount of power to be consumed when the position information detected by the position information detection section coincides with the position information set in the location information setting section; and

the recharge notification section makes the notification when the position information detected by the position information detection section coincides with the position information set in the location information setting section.

Thus, the user is notified that the battery needs to be recharged at a point in time when the user can recharge the battery or a location where the user can recharge the battery, thereby preventing the user from forgetting about recharging the battery. Therefore, it is possible to realize a battery-powered television broadcast reception device in which it is possible to prevent a situation where the battery runs down inadvertently while viewing a program.

An eighth aspect of the present invention is directed to a device for controlling a battery-powered television broadcast reception device, including:

a program-to-view setting section in which a plurality of program information are set, each program information including a starting time and a finishing time of a program to be viewed;

a viewing duration calculating section for calculating a viewing duration for each program information set in the program-to-view setting section by subtracting the starting time from the finishing time, and also calculating a total viewing duration by adding together the viewing durations of all program information set in the program-to-view setting section;

a power consumption calculating section for calculating a total amount of power to be consumed for viewing programs over a period of the total viewing duration;

a battery level detection section for detecting a battery level of the battery; and

a recharge determination section for determining that the battery needs to be recharged when the total amount of power to be consumed is greater than the battery level obtained by the battery level obtaining section.

Thus, when the battery level is not high enough for viewing a program, it is determined in advance that the battery needs to be recharged, thereby realizing a battery-powered television broadcast reception device in which it is possible to prevent a situation where the battery runs down inadvertently while viewing a program.

A ninth aspect of the present invention is directed to the device for controlling a television broadcast reception device of the eighth aspect, wherein:

the viewing duration calculating section calculates, for each program information set in the program-to-view setting section, an accumulative viewing duration by adding together the viewing duration of the subject program information and that of program information for a program whose starting time is earlier than that of the subject program information;

the power consumption calculating section calculates, as the total amount of power to be consumed, an amount of power to be consumed for viewing programs over a period of the accumulative viewing duration; and

the recharge determination section determines that the programs cannot be viewed when the total amount of power to be consumed is greater than the battery level detected by the battery level detection section.

Thus, the accumulative viewing duration is calculated for each selected program. Therefore, the user can identify which program or programs can be viewed with the current battery level.

A tenth aspect of the present invention is directed to the television broadcast reception device of the first aspect, wherein:

the battery has a function of detecting a battery level; and

a battery level obtaining section for obtaining the battery level from the battery is provided instead of the battery level detection section.

Thus, it is possible to realize a television broadcast reception device using a smart battery, or the like, that has a function of detecting the battery level of itself, wherein when the battery level is not high enough for viewing a program, the user is notified in advance that the battery needs to be recharged.

An eleventh aspect of the present invention is directed to a battery-powered television broadcast reception device, including:

a signal receiving section for receiving a television broadcasting signal;

a recording section for recording video data and audio data of a program included in the television broadcasting signal received by the signal receiving section;

a program-to-record setting section in which a plurality of program information are set, each program information including a starting time and a finishing time of a program to be recorded;

a recording duration calculating section for calculating a recording duration for each program information set in the program-to-record setting section by subtracting the starting time from the finishing time, and also calculating a total recording duration by adding together the recording durations of all program information set in the program-to-record setting section;

a power consumption calculating section for calculating a total amount of power to be consumed by the signal receiving section and the recording section operating over a period of the total recording duration;

a battery level detection section for detecting a battery level of the battery; and

a recharge notification section for notifying the user that the battery needs to be recharged when the total amount of power to be consumed is greater than the battery level detected by the battery level detection section.

Thus, when the battery level is not high enough for recording a program, the user is notified in advance that the battery needs to be recharged, thereby realizing a battery-powered television broadcast reception device in which it is possible to prevent a situation where the battery runs down inadvertently while viewing a program.

### EFFECTS OF THE INVENTION

According to the present invention, it is possible to realize a battery-powered television broadcast reception device in which it is possible to prevent a situation where the battery runs down inadvertently while viewing a program.

### BRIEF DESCRIPTION OF THE DRAWINGS

FIG. 1 A block diagram showing a configuration of a television broadcast reception device according to Embodiment 1 of the present invention.

FIG. 2 A flow chart showing a power management process to be performed in the television broadcast reception device according to Embodiment 1 of the present invention.

FIG. 3 A table showing an example of a set of information to be set in a program-to-view setting section, i.e., the program information of each program, the duration of each program, and the amount of power to be consumed for viewing each program.

FIG. 4 A diagram showing an example of what is displayed on an liquid crystal display in the television broadcast reception device according to Embodiment 1 of the present invention.

FIG. 5 A block diagram showing a configuration of a television broadcast reception device according to Embodiment 2 of the present invention.

FIG. 6 A flow chart showing a power management process to be performed in the television broadcast reception device according to Embodiment 2 of the present invention.

FIG. 7 A diagram showing an example of what is displayed on an liquid crystal display in the television broadcast reception device according to Embodiment 2 of the present invention.

FIG. 8 A block diagram showing a configuration of a television broadcast reception device according to Embodiment 3 of the present invention.

FIG. 9 A flow chart showing a power management process to be performed in the television broadcast reception device according to Embodiment 3 of the present invention.

FIG. 10 A table showing an example of a set of information to be set in a program-to-view setting section of the television broadcast reception device according to Embodiment 3 of the present invention, i.e., the program information of each program, the duration of each program, and the amount of power to be consumed for viewing each program.

FIG. 11 A block diagram showing a configuration of a television broadcast reception device according to Embodiment 4 of the present invention.

FIG. 12 A flow chart showing a power management process to be performed in the television broadcast reception device according to Embodiment 4 of the present invention.

FIG. 13 A table showing an example of a set of information to be set in a program-to-view setting section of the television broadcast reception device according to Embodiment 4 of the present invention, i.e., the program information of each program, the duration of each program, and the amount of power to be consumed for viewing each program.

FIG. 14 A diagram showing an example of what is displayed on an liquid crystal display in the television broadcast reception device according to Embodiment 4 of the present invention.

FIG. 15 A diagram showing another example of what is displayed on an liquid crystal display in the television broadcast reception device according to Embodiment 4 of the present invention.

FIG. 16 A block diagram showing a configuration of a television broadcast reception device according to Embodiment 5 of the present invention.

FIG. 17 A flow chart showing a power management process to be performed in the television broadcast reception device according to Embodiment 5 of the present invention.

FIG. 18 A table showing an example of a set of information to be set in a program-to-view setting section of the television broadcast reception device according to Embodiment 5 of the present invention, i.e., the program information of each program, the duration of each program, and the amount of power to be consumed for viewing each program.

FIG. 19 A block diagram showing a configuration of a television broadcast reception device according to Embodiment 6 of the present invention.

FIG. 20 A block diagram showing a configuration of a television broadcast reception device according to Embodiment 7 of the present invention.

FIG. 21 A block diagram showing a configuration of a television broadcast reception device according to Embodiment 8 of the present invention.

FIG. 22 A flow chart showing a power management process to be performed in the television broadcast reception device according to Embodiment 8 of the present invention.

FIG. 23 A block diagram showing a configuration of a television broadcast reception device according to Embodiment 9 of the present invention.

FIG. 24 A flow chart showing a power management process to be performed in the television broadcast reception device according to Embodiment 9 of the present invention.

### DESCRIPTION OF REFERENCE NUMERALS

100 Television broadcast reception device
101 Signal receiving section
102 Reproduction section
103 Liquid crystal display
104 Key input section
105 Program-to-view setting section
106 Viewing duration calculating section
107 Power consumption calculating section
108 Battery
109 Battery level detection section
110 Recharge notification section
111 Speaker
200 Television broadcast reception device
204 Program information obtaining section
205 Program-to-view setting section
300 Television broadcast reception device
304 Program information obtaining section
304a Extension time obtaining section
306 Viewing duration calculating section
400 Television broadcast reception device
406 Viewing duration calculating section
407 Power consumption calculating section
500 Television broadcast reception device
506 Mobile telephone section
507 Power consumption calculating section
600 Television broadcast reception device
601 Warning timing management section
601a Time setting section
601b Timer section
607 Power consumption calculating section
609 Battery level detection section
610 Recharge notification section
700 Television broadcast reception device
701 Warning timing management section
701a Location information setting section
701b GPS section
707 Power consumption calculating section
709 Battery level detection section
710 Recharge notification section
800 Television broadcast reception device
801 Battery level obtaining section
900 Television broadcast reception device
901 Program-to-record setting section
902 Recording section
903 Recording duration calculating section

### BEST MODE FOR CARRYING OUT THE INVENTION

Embodiments of the present invention will now be described with reference to the drawings.

### Embodiment 1

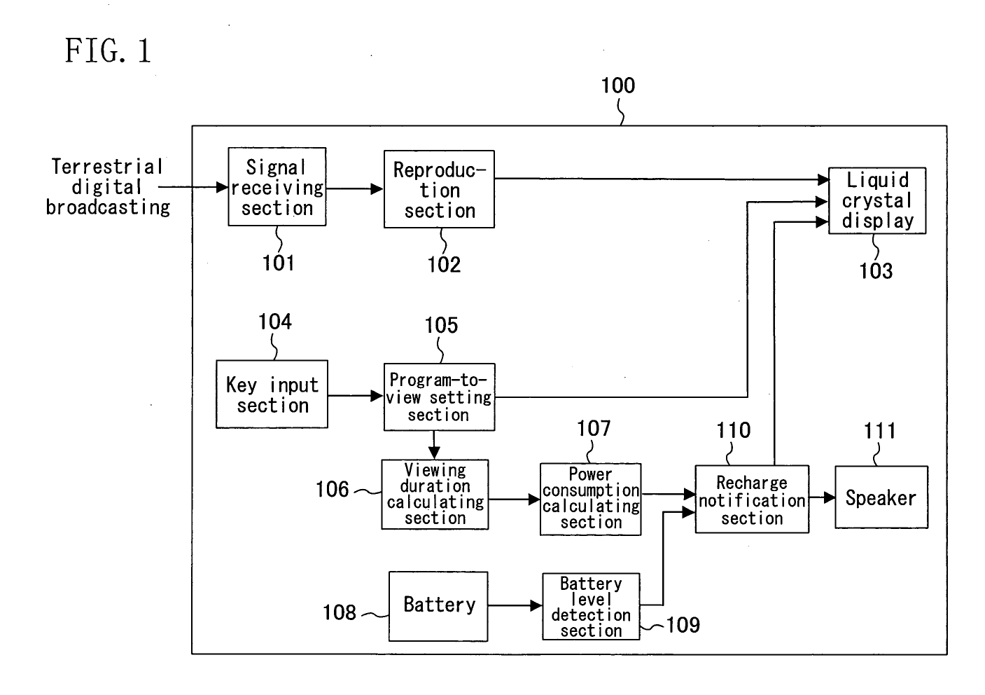

FIG. 1 is a block diagram showing a configuration of a television broadcast reception device 100 according to Embodiment 1 of the present invention. Referring to FIG. 1, the television broadcast reception device 100 includes a signal receiving section 101, a reproduction section 102, a liquid crystal display 103, a key input section 104, a program-to-view setting section 105, a viewing duration calculating section 106, a power consumption calculating section 107, a battery 108, a battery level detection section 109, a recharge notification section 110, and a speaker 111.

The signal receiving section 101 receives terrestrial digital broadcasting signals.

The reproduction section 102 extracts video data and audio data (hereinafter video data and audio data are referred to collectively as “audio video data”) of a selected program from the terrestrial digital broadcasting transport stream received by the signal receiving section 101, and decodes and reproduces the audio video data so that the video is displayed on the liquid crystal display 103.

The liquid crystal display 103 displays the audio video data reproduced by the reproduction section 102, and program information such as the channel selected by the user and the battery level.

The key input section 104 outputs, to the program-to-view setting section 105, program information, e.g., the channel number, the starting time and the finishing time, of the program specified by the user operating keys thereon (a program to be viewed).

The program information output from the key input section 104 are set (stored) in the program-to-view setting section 105 as a program to be viewed, and output from the program-to-view setting section 105 to the liquid crystal display 103.

The viewing duration calculating section 106 calculates the viewing duration for each program information stored in the program-to-view setting section 105 by subtracting the starting time of the program from the finishing time thereof, and also calculates the total viewing duration by adding together the viewing durations of all the selected programs.

The power consumption calculating section 107 calculates the amount of power to be consumed by the signal receiving section 101 and the reproduction section 102 operating over a period of the total viewing duration.

The battery 108 is a rechargeable battery, and supplies power to various parts of the television broadcast reception device 100.

The battery level detection section 109 detects the battery level of the battery 108.

The recharge notification section 110 outputs a warning alarm from the speaker 111 and displays a warning message (e.g., “Battery needs to be recharged”) on the liquid crystal display 103 in order to notify the user that the battery needs to be recharged, when the amount of power to be consumed is greater than the battery level.

The speaker 111 outputs the warning alarm.

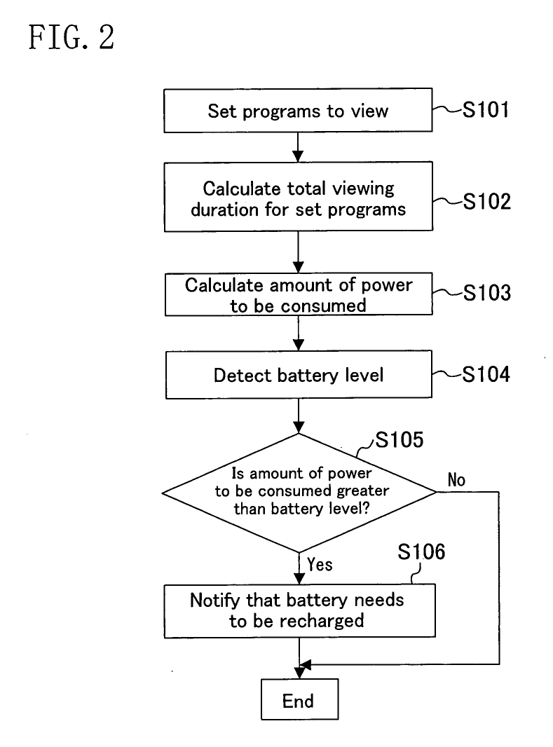

The television broadcast reception device 100 having such a configuration performs the process shown in the flow chart of FIG. 2 to thereby prevent a situation where the battery runs down inadvertently while viewing a program. The process in each step will now be described.

Step S101

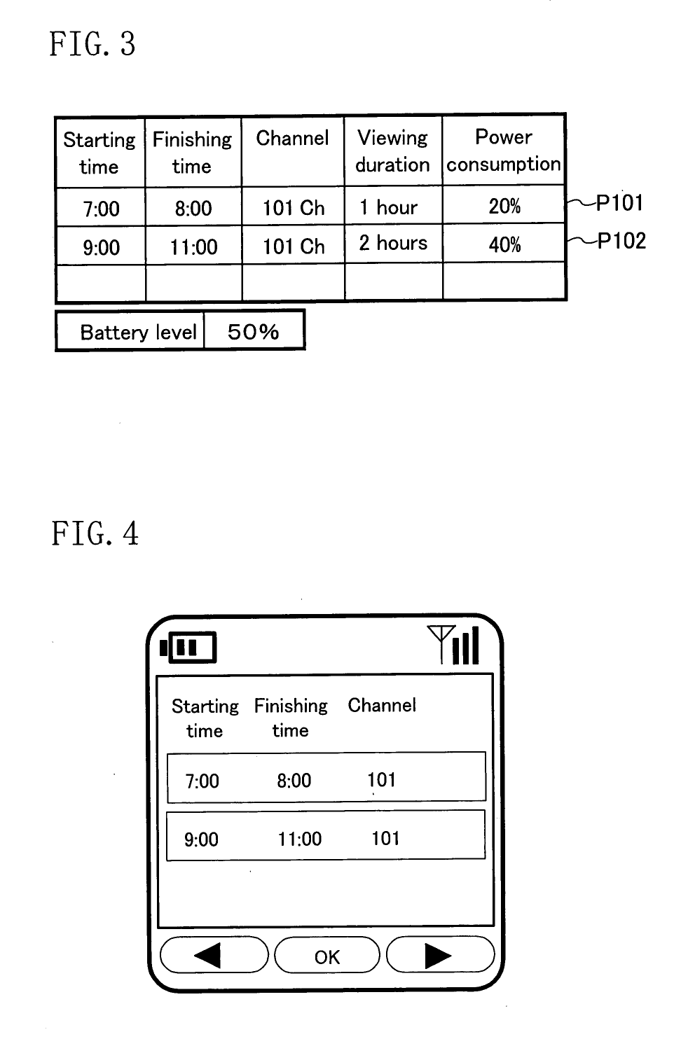

The user operates the key input section 104 to input program information of a program to view, such as the channel number, the starting time and the finishing time of the program, and the input program information is set in the program-to-view setting section 105. The program-to-view setting section 105 displays the set program information on the liquid crystal display 103, and outputs the program information to the viewing duration calculating section 106. For example, where programs P101 and P102 are set as shown in FIG. 3, the display on the liquid crystal display 103 will be as shown in FIG. 4.

Step S102

The viewing duration calculating section 106 calculates the viewing duration for each program information by subtracting the starting time of the program information from the finishing time thereof, and also calculates the total viewing duration by adding together the viewing durations of all the selected programs. For example, where the programs P101 and P102 are set as described above, the viewing duration of the program P101 is calculated to be one hour, that of the program P102 is calculated to be two hours, and the total viewing duration is calculated to be three hours.

Step S103

The power consumption calculating section 107 calculates the amount of power to be consumed by the signal receiving section 101 and the reproduction section 102 operating over a period of the total viewing duration, based on the total viewing duration calculated in the viewing duration calculating section 106. For example, where the operation of the signal receiving section 101 and the reproduction section 102 over one hour consumes 20% of the power of the battery fully charged, the amount of power to be consumed over the total viewing duration of three hours is calculated to be 60% of the power of the battery fully charged.

Step S104

The battery level detection section 109 detects the battery level of the battery 108. For example, assume that the battery level is detected to be 50%.

Step S105

The recharge notification section 110 proceeds to step S106 when the amount of power to be consumed is greater than the battery level, and exits the process when the amount of power to be consumed is less than the battery level. In the above example, the process proceeds to step S106 because the calculated amount of power to be consumed (60%) is greater than the battery level (50%).

Step S106

The recharge notification section 110 notifies the user that the battery needs to be recharged. Specifically, a warning alarm is output to the speaker 111, and a message “Battery needs to be recharged” is displayed on the liquid crystal display 103.

As described above, according to the present embodiment, the amount of power to be consumed by the signal receiving section 101 and the reproduction section 102 is calculated based on the total viewing duration for programs set by the user as being programs to view. If the battery level is less than the calculated amount of power, the user is notified that the battery needs to be recharged. Therefore, it is possible to prevent a situation where the battery runs down inadvertently while viewing a program.

### Embodiment 2

This embodiment is an example of a device with which the user can more easily set programs to view.

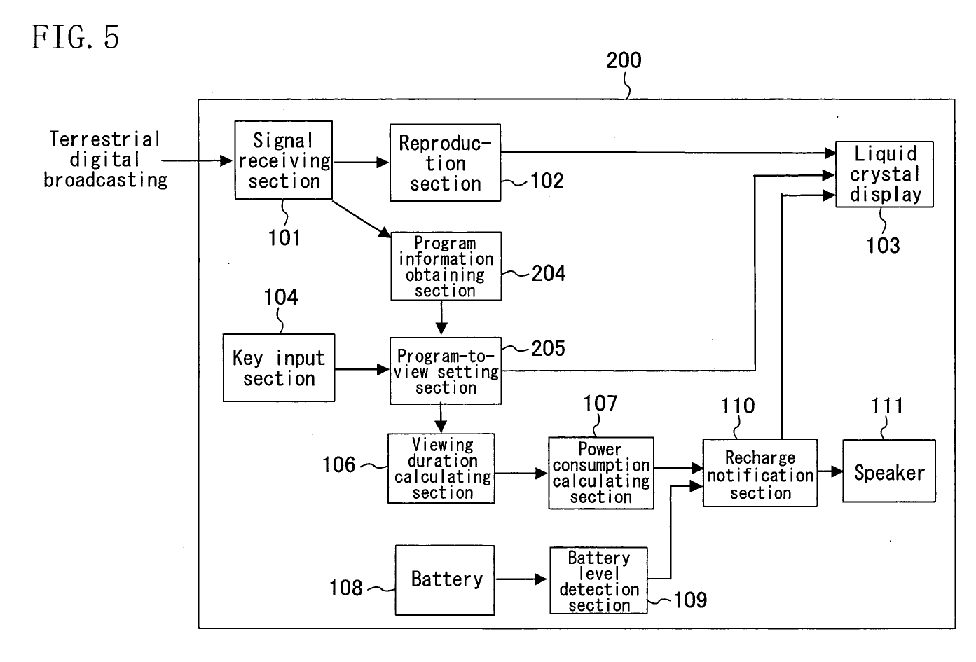

FIG. 5 is a block diagram showing a configuration of a television broadcast reception device 200 according to Embodiment 2 of the present invention. Referring to FIG. 5, the television broadcast reception device 200 is different from the television broadcast reception device 100 in that a program information obtaining section 204 is added to the television broadcast reception device 100, and a program-to-view setting section 205 is provided instead of the program-to-view setting section 105. In the following subsequent embodiments, components functionally equal to those of Embodiment 1 will be denoted by like reference numerals and will not be further described below.

The program information obtaining section 204 extracts program information, such as the title, the starting time and the finishing time, of various programs, from the terrestrial digital broadcasting transport stream received by the signal receiving section 101, and outputs the program information to the program-to-view setting section 205.

The program-to-view setting section 205 produces an electronic program guide from the program information and displays the produced electronic program guide on the liquid crystal display 103.

The program information of programs selected by the user operating the key input section 104 from among programs listed in the electronic program guide (programs to view) are set in the program-to-view setting section 205 as programs to be viewed.

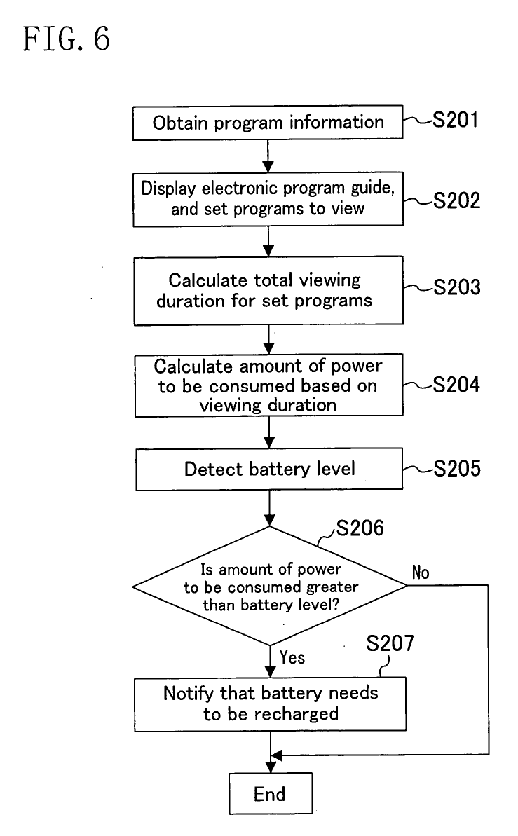

The television broadcast reception device 200 having such a configuration performs the process shown in the flow chart of FIG. 6 to thereby prevent a situation where the battery runs down inadvertently while viewing a program. The process in each step will now be described.

Step S201

The program information obtaining section 204 extracts program information from the terrestrial digital broadcasting transport stream received by the signal receiving section 101, and outputs the program information to the program-to-view setting section 205.

Step S202

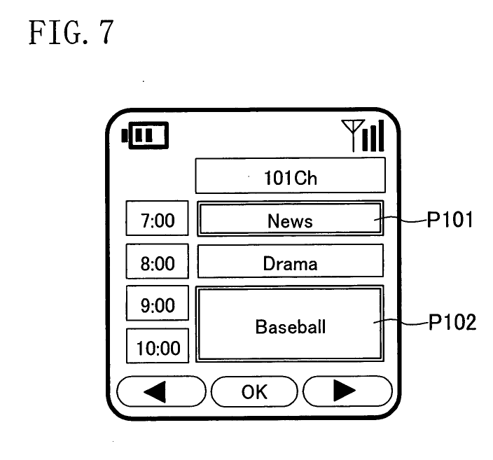

The program-to-view setting section 205 produces an electronic program guide from the program information and displays the produced electronic program guide on the liquid crystal display 103. Then, when the user operates the key input section 104 to select a program to view from the electronic program guide, the program selected by the user is set as a program to be viewed. FIG. 7 shows an example where the user selects a program to view on the electronic program guide displayed on the liquid crystal display 103. In this example, news of the program P101 and baseball of the program P102 are being selected. With the present device, a program being selected is indicated by a double-line frame around the program.

Steps S203 to S207

Steps S203 to S207 are the same as steps S102 to S106, respectively, of Embodiment 1.

Therefore, also in the present embodiment, the amount of power to be consumed by the signal receiving section 101 and the reproduction section 102 is calculated based on the total viewing duration for programs set by the user as programs to view. If the battery level is less than the calculated amount of power to be consumed, the device notifies the user that the battery needs to be recharged. Therefore, it is possible to prevent a situation where the battery runs down inadvertently while viewing a program.

Moreover, the user can select a program to view from the electronic program guide on the display, whereby it is easier for the user to set a program to be viewed.

The present embodiment is directed to an example where each program being selected on the electronic program guide is displayed with a double-line frame. Alternatively, selected programs and non-selected programs can be distinguished from each other by various other methods, e.g., using different colors inside the frames.

An example where program information is obtained from the received terrestrial digital broadcasting transport stream has been described above. Alternatively, where the present device is built in a mobile telephone, for example, program information may be obtained from the Internet by using the communications function of the mobile telephone.

### Embodiment 3

This embodiment is an example of a device with which it is possible to prevent a situation where the battery runs down inadvertently while viewing a program, even when viewing a program that may possibly be extended to a later finishing time.

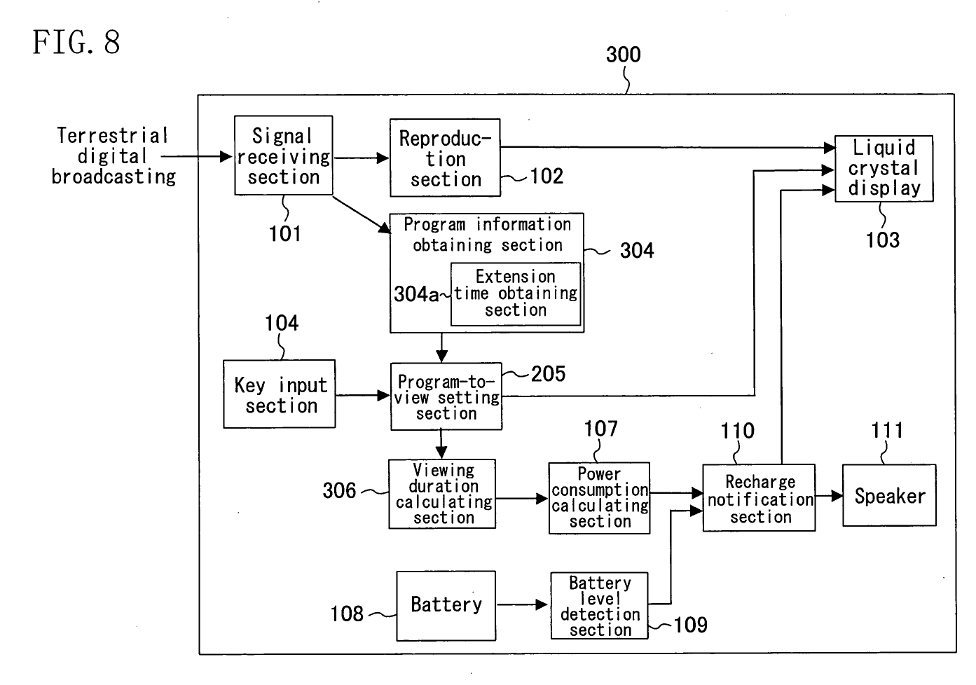

FIG. 8 is block diagram showing a configuration of a television broadcast reception device 300 according to Embodiment 3 of the present invention. The television broadcast reception device 300 is different from the television broadcast reception device 200 of Embodiment 2 in that a program information obtaining section 304 is provided instead of the program information obtaining section 204, and a viewing duration calculating section 306 is provided instead of the viewing duration calculating section 106.

The program information obtaining section 304 includes an extension time obtaining section 304a for extracting the length of extension of a program from the terrestrial digital broadcasting transport stream received by the signal receiving section 101. The program information obtaining section 304 outputs program information, such as the title, the starting time and the finishing time, extracted from the terrestrial digital broadcasting transport stream received by the signal receiving section 101, and the length of extension extracted by the extension time obtaining section 304a, to the program-to-view setting section 205.

The viewing duration calculating section 306 calculates the viewing duration for each program set in the program-to-view setting section 205 by subtracting the starting time of the program information from the finishing time thereof and then adding the length of extension thereto, and also calculates the total viewing duration by adding together the viewing durations of all the selected programs.

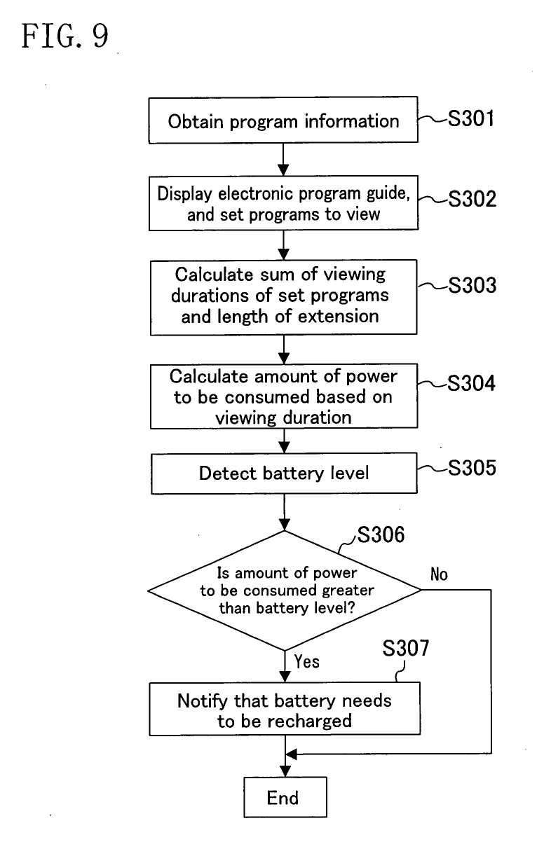

The television broadcast reception device 300 having such a configuration performs the process shown in the flow chart of FIG. 9 to thereby prevent a situation where the battery runs down inadvertently while viewing a program. The process in each step will now be described.

Step S301

The program information obtaining section 304 extracts program information such as the title, the starting time and the finishing time, from the received terrestrial digital broadcasting transport stream. Moreover, the extension time obtaining section 304a extracts the length of extension of each program from the transport stream.

Step S302

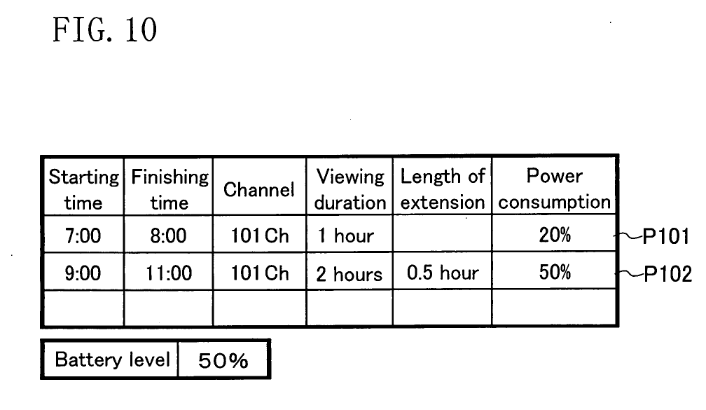

The program-to-view setting section 205 produces an electronic program guide from the program information and displays the produced electronic program guide on the liquid crystal display 103. Then, when the user operates the key input section 104 to select a program to view from the electronic program guide, the program selected by the user is set as a program to be viewed. In the following description, it is assumed that the programs P101 and P102 are being set as shown in the table of FIG. 10.

Step S303

The viewing duration calculating section 306 calculates the viewing duration of each selected program by subtracting the starting time of the program information from the finishing time thereof and then adding the length of extension thereto, and also calculates the total viewing duration by adding together the viewing durations of all the selected programs. In the example shown in the table of FIG. 10, the viewing duration of the program P101 is one hour, the viewing duration of the program P102 is two hours, and the length of extension is 0.5 hour. Therefore, the total viewing duration is calculated to be 3.5 hours.

Step S304

The power consumption calculating section 107 calculates the amount of power to be consumed by the signal receiving section 101 and the reproduction section 102 operating over a period of the total viewing duration. For example, where the operation of the signal receiving section 101 and the reproduction section 102 over one hour consumes 20% of the power of the battery fully charged, the amount of power to be consumed over the total viewing duration of 3.5 hours is calculated to be 70%.

Steps S305 to S307

Steps S305 to S307 are the same as steps S104 to S106, respectively, of Embodiment 1.

Therefore, also in the present embodiment, the amount of power to be consumed by the signal receiving section 101 and the reproduction section 102 is calculated based on the total viewing duration for programs set by the user as programs to view. If the battery level is less than the calculated amount of power to be consumed, the device notifies the user that the battery needs to be recharged. Therefore, it is possible to prevent a situation where the battery runs down inadvertently while viewing a program.

Moreover, the length of extension of each program obtained by the extension time obtaining section 304a is added to the total viewing duration. Therefore, it is possible to prevent a situation where the battery runs down inadvertently while viewing a program, even when viewing a program that may possibly be extended to a later finishing time, such as live coverage of a sporting event.

### Embodiment 4

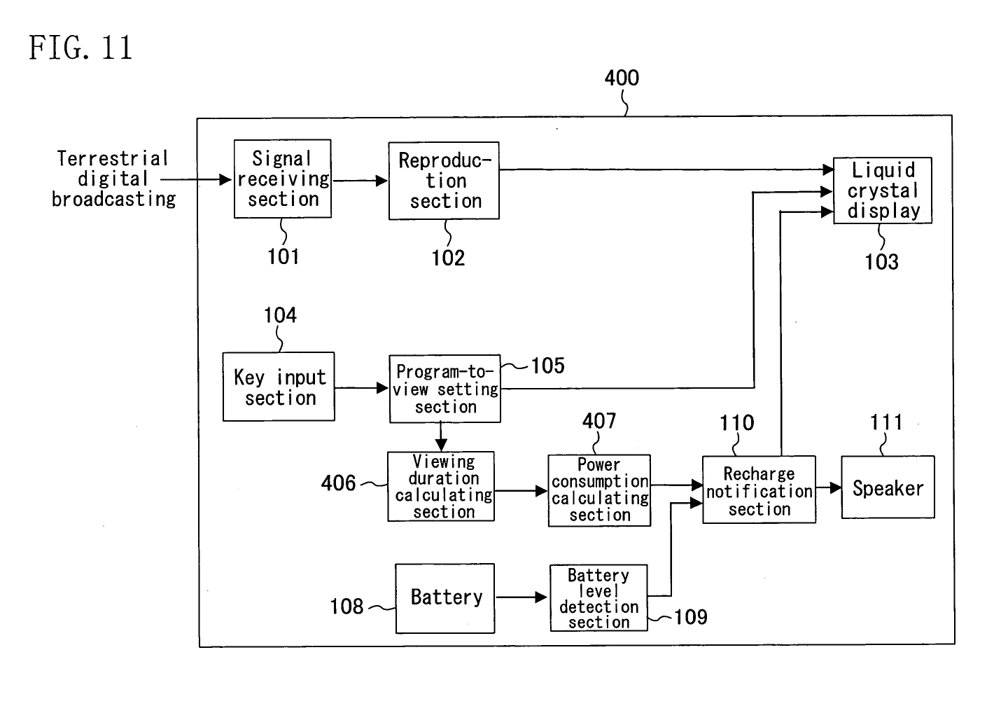

FIG. 11 is a block diagram showing a configuration of a television broadcast reception device 400 according to Embodiment 4 of the present invention. Referring to FIG. 11, the television broadcast reception device 400 is different from the television broadcast reception device 100 of Embodiment 1 in that a viewing duration calculating section 406 is provided instead of the viewing duration calculating section 106, and a power consumption calculating section 407 is provided instead of the power consumption calculating section 107.

The viewing duration calculating section 406 calculates the viewing duration of each program set in the program-to-view setting section 105, by subtracting the starting time of the program information from the finishing time thereof, and also calculates the accumulative viewing duration by adding together the viewing duration of the program and that of another program whose starting time is earlier than the program.

The power consumption calculating section 407 calculates the amount of power to be consumed by the signal receiving section 101 and the reproduction section 102 operating over a period of the accumulative viewing duration.

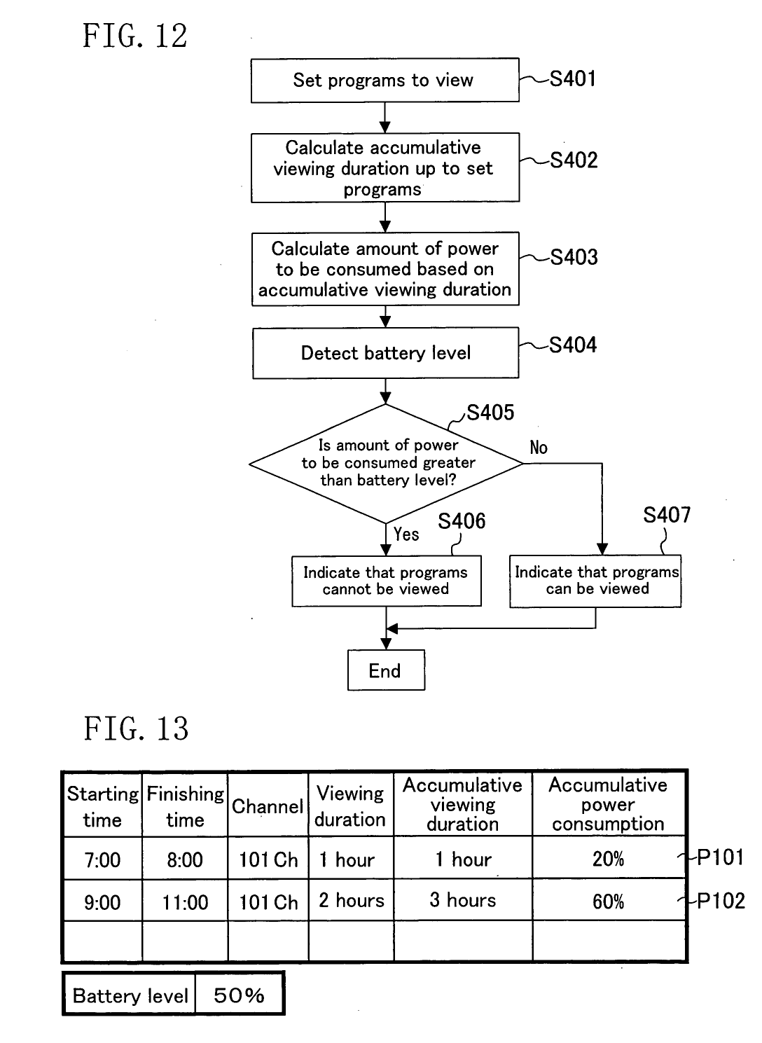

The television broadcast reception device 400 having such a configuration performs the process shown in the flow chart of FIG. 12 to thereby prevent a situation where the battery runs down inadvertently while viewing a program. The process in each step will now be described.

Step S401

The user operates the key input section 104 to input program information of a program to view, such as the channel number, the starting time and the finishing time of the program, and the input program information is set in the program-to-view setting section 105. The program-to-view setting section 105 displays the set program information on the liquid crystal display 103, and outputs the program information to the viewing duration calculating section 406.

Step S402

The viewing duration for each program set in the program-to-view setting section 105 is calculated by subtracting the starting time of the program information from the finishing time thereof, and the accumulative viewing duration is also calculated by adding together the viewing duration of the program and that of another program whose starting time is earlier than the program. In the example shown in the table of FIG. 13, the accumulative viewing duration of the program P101 is calculated to be one hour, the accumulative viewing duration of the program P102 is calculated to be three hours by adding together the viewing durations of the programs P101 and P102.

Step S403

The power consumption calculating section 407 calculates the accumulative amount of power to be consumed by the signal receiving section 101 and the reproduction section 102 operating over a period of the accumulative viewing duration. Where the operation of the signal receiving section 101 and the reproduction section 102 over one hour consumes 20% of the power of the battery fully charged, the accumulative power consumption of the program P101 is calculated to be 20% and that of the program P102 is calculated to be 60%.

Step S404

The battery level detection section 109 detects the battery level of the battery 108. For example, assume that the battery level is detected to be 50%.

Then, steps 405 to 407 are performed for each program set in the program-to-view setting section 105.

Step S405

The recharge notification section 110 proceeds to step S406 if the accumulative power consumption for the program is greater than the battery level, and to step S407 if the accumulative power consumption is less than the battery level.

Step S406

The recharge notification section 110 indicates, on the liquid crystal display 103, that programs cannot be viewed. For example, it is indicated that the programs cannot be viewed because the accumulative power consumption of the program P102 is 60%, which is greater than the battery level being 50%.

Step S407

The program-to-view setting section 105 indicates, on the liquid crystal display 103, that the programs can be viewed. For example, it is indicated that the programs can be viewed because the accumulative power consumption of the program P101 is 20%, which is less than the battery level being 50%.

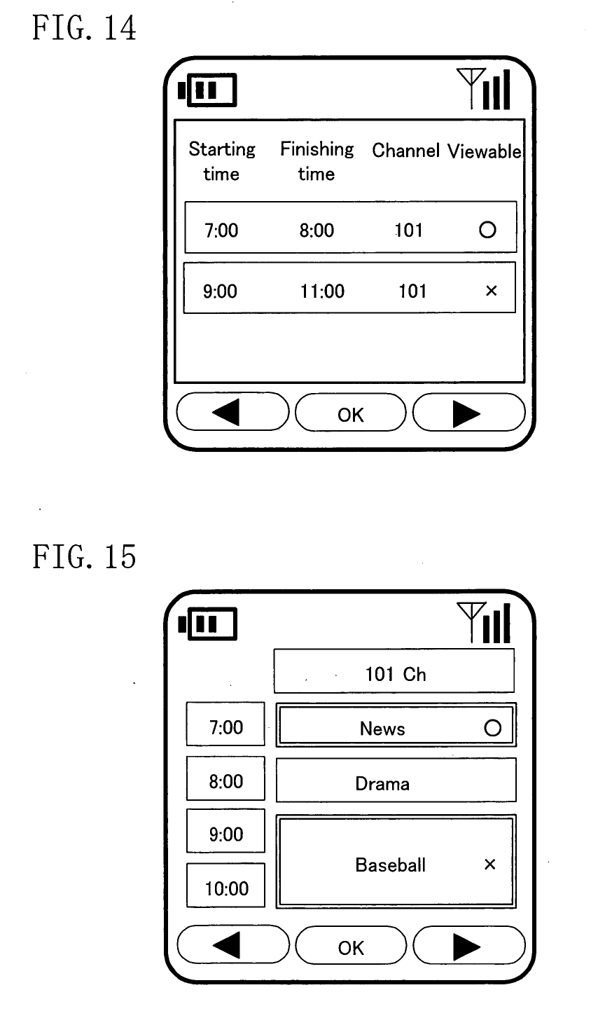

FIG. 14 is an example where a device, such as the television broadcast reception device 100, showing the starting time, the finishing time and the channel of each program as the program information also shows whether each program can be viewed. FIG. 15 is an example where a device, such as the television broadcast reception device 200, showing the starting time, the title and the channel of each program as the program information also shows whether each program can be viewed. In these examples, a circle symbol is displayed toward the right side of the frame in which the program P101 is shown to thereby indicate that the program P101 can be viewed, whereas an X-shaped symbol is displayed to thereby indicate that the program P102 cannot be viewed.

As described above, in the present embodiment, the accumulative viewing duration is calculated for each selected program. Therefore, the user can identify which program or programs can be viewed with the current battery level. Thus, if it is not possible to view all of the selected programs due to a low battery level, the user can re-select programs by narrowing down the list of programs to view.

The method for distinguishing between programs that can be viewed and those that cannot be viewed (using a circle symbol and an X-shaped symbol) is merely illustrative. For example, another method may be to use different colors inside the frames for programs displayed on the liquid crystal display 103 that can be viewed and those that cannot be viewed.

### Embodiment 5

This embodiment is an example where a television broadcast reception device is combined with a mobile telephone.

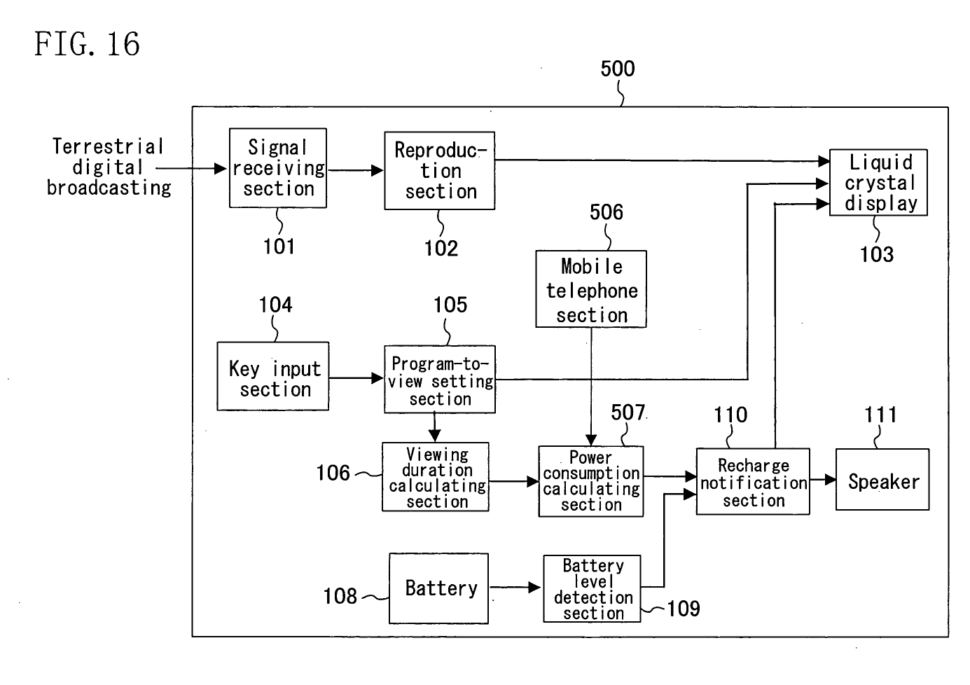

FIG. 16 is a block diagram showing a configuration of a television broadcast reception device 500 according to Embodiment 5 of the present invention. Referring to FIG. 16, the television broadcast reception device 500 is different from the television broadcast reception device 100 of Embodiment 1 in that the television broadcast reception device 500 further includes a mobile telephone section 506, and a power consumption calculating section 507 is provided instead of the power consumption calculating section 107.

The mobile telephone section 506 receives the power supply voltage from the battery 108. Moreover, information used for calculating the power consumption of the mobile telephone section 506 is output from the mobile telephone section 506 to the power consumption calculating section 507.

The power consumption calculating section 507 calculates the amount of power to be consumed by the signal receiving section 101 and the reproduction section 102 operating over a period of the total viewing duration, and also calculates the total amount of power to be consumed by the mobile telephone section 506 operating in a stand-by mode from the present point in time until the finishing time of the program to be viewed.

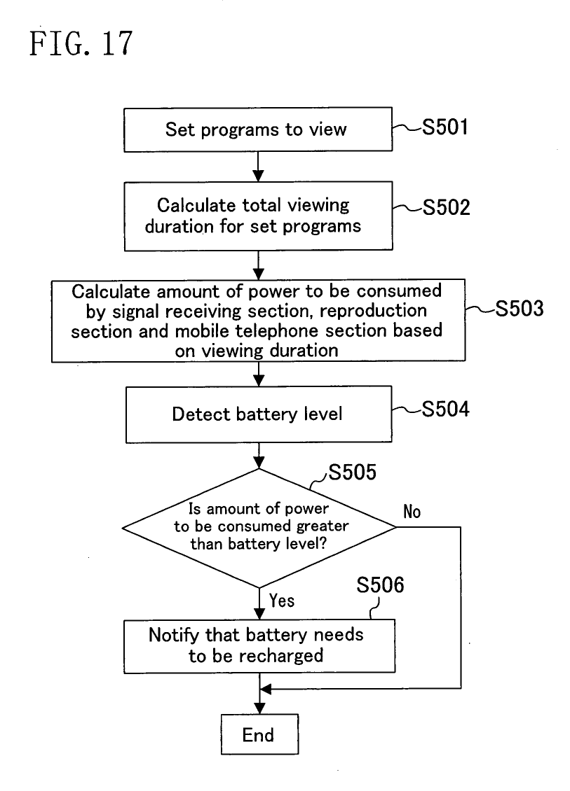

The television broadcast reception device 500 having such a configuration performs the process shown in the flow chart of FIG. 17 to thereby prevent a situation where the battery runs down inadvertently while viewing a program. The process in each step will now be described.

Steps S501 to S502

Steps S501 to S502 are the same as steps S101 to S102, respectively, of Embodiment 1.

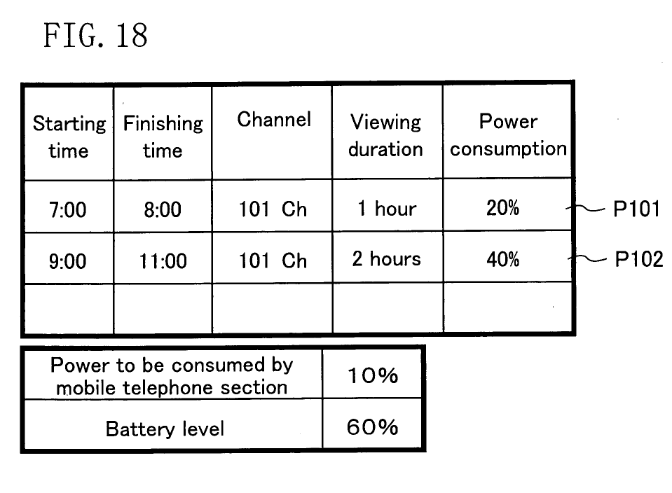

Thus, through these processes, the program information input by the user are displayed on the liquid crystal display 103, while the viewing duration of each selected program is calculated and the total viewing duration is also calculated (see FIG. 18).

Step S503

The power consumption calculating section 507 calculates the amount of power to be consumed by the signal receiving section 101 and the reproduction section 102 operating over a period of the total viewing duration, and the total amount of power to be consumed by the mobile telephone section 506 operating in a stand-by mode from the present point in time until the finishing time of the program.

Where the operation of the signal receiving section 101 and the reproduction section 102 over one hour consumes 20% of the power of the battery fully charged, the power consumption of the program P10 is calculated to be 20%, that of the program P102 is calculated to be 40%, and that of the mobile telephone section 506 is calculated to be 10%, with the total power consumption being calculated to be 70%, in the example shown in the table of FIG. 18.

Step S504

The battery level detection section 109 detects the battery level of the battery 108. For example, assume that the battery level is detected to be 60%.

Step S505

The recharge notification section 110 proceeds to step S506 when the amount of power to be consumed is greater than the battery level, and exits the process when the amount of power to be consumed is less than the battery level. In the above example, the process proceeds to step S506 because the calculated amount of power to be consumed (70%) is greater than the battery level (60%).

Step S506

The recharge notification section 110 notifies the user that the battery needs to be recharged. Specifically, a warning alarm is output to the speaker 111, and a message “Battery needs to be recharged” is displayed on the liquid crystal display 103.

As described above, in the present embodiment, the device calculates the total power consumption by adding together the amount of power to be consumed by the operation of the signal receiving section 101 and the reproduction section 102 and the amount of power to be consumed by the operation of the mobile telephone section 506. If the battery level is less than the calculated amount of power to be consumed, the device notifies the user that the battery needs to be recharged, whereby it is possible to prevent a situation where the battery runs down inadvertently while viewing a program.

### Embodiment 6

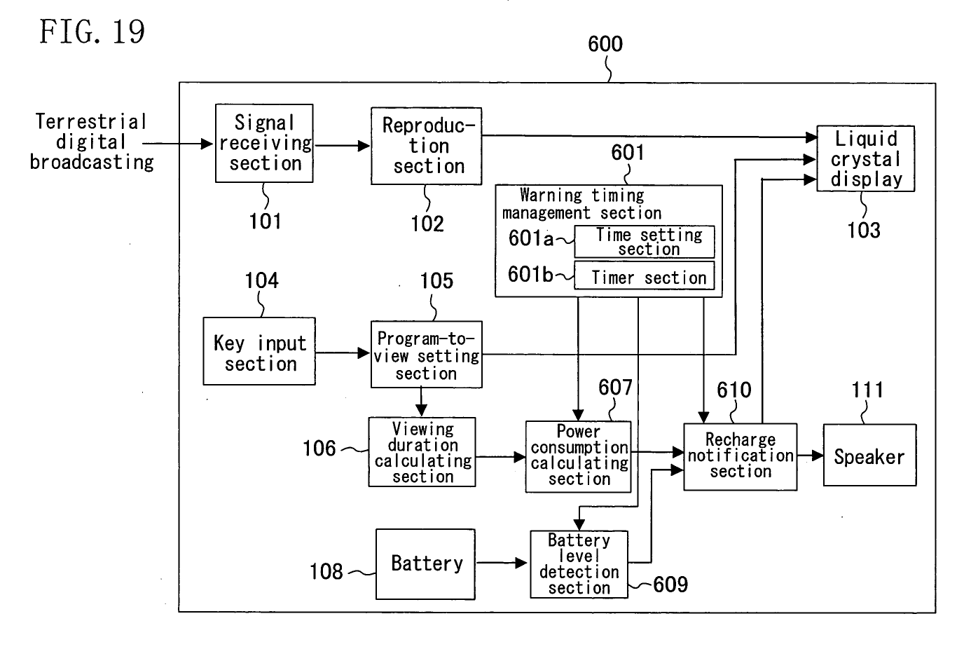

FIG. 19 is a block diagram showing a configuration of a television broadcast reception device 600 according to Embodiment 6 of the present invention. Referring to FIG. 19, the television broadcast reception device 600 is different from the television broadcast reception device 100 in that the television broadcast reception device 600 further includes a warning timing management section 601, a power consumption calculating section 607 is provided instead of the power consumption calculating section 107, a battery level detection section 609 is provided instead of the battery level detection section 109, and a recharge notification section 610 is provided instead of the recharge notification section 110.

The warning timing management section 601 includes a time setting section 601a and a timer section 601b.

Time slots in which the user can recharge the battery are set in the time setting section 601a.

When the current time matches a time set in the time setting section 601a, the timer section 601b outputs a time match signal indicating that the current time matches the time set in the time setting section 601a.

The power consumption calculating section 607 calculates the amount of power to be consumed by the signal receiving section 101 and the reproduction section 102 operating over a period of the total viewing duration, when the timer section 601b outputs the time match signal.

The battery level detection section 609 detects the battery level of the battery 108 when the timer section 601b outputs the time match signal.

The recharge notification section 610 outputs a warning alarm from the speaker 111 and displays a warning message on the liquid crystal display 103 in order to notify the user that the battery needs to be recharged, if the amount of power to be consumed is greater than the battery level when the timer section 601b outputs the time match signal.

With the television broadcast reception device 600 having such a configuration, the amount of power needed is calculated in the power consumption calculating section 607 and the battery level is detected by the battery level detection section 609, when a current time matches a time set in the time setting section 601a. If the amount of power to be consumed calculated in the power consumption calculating section 607 is greater than the battery level, the recharge notification section 610 notifies the user that the battery needs to be recharged.

For example, when the recharge notification section 610 notifies the user that the battery needs to be recharged during the use of the television broadcast reception device, the user may be out at that point and therefore cannot recharge the battery, in which case the user needs to recharge the battery when the user comes home. However, the user may forget to recharge the battery by the time the user comes home, in which case the battery may run down inadvertently while the user is viewing a program.

In contrast, with the television broadcast reception device 600, the user can set, in the time setting section 601a, the time when the user comes home. Then, the recharge notification section 610 notifies the user that the battery needs to be recharged at the time to come home, which has been set by the user. Thus, it is possible to prevent the user from forgetting to recharge the battery.

While an example where the time to come home is set in the time setting section 601a has been described above, any other time can be set as long as it is when the user can recharge the battery.

### Embodiment 7

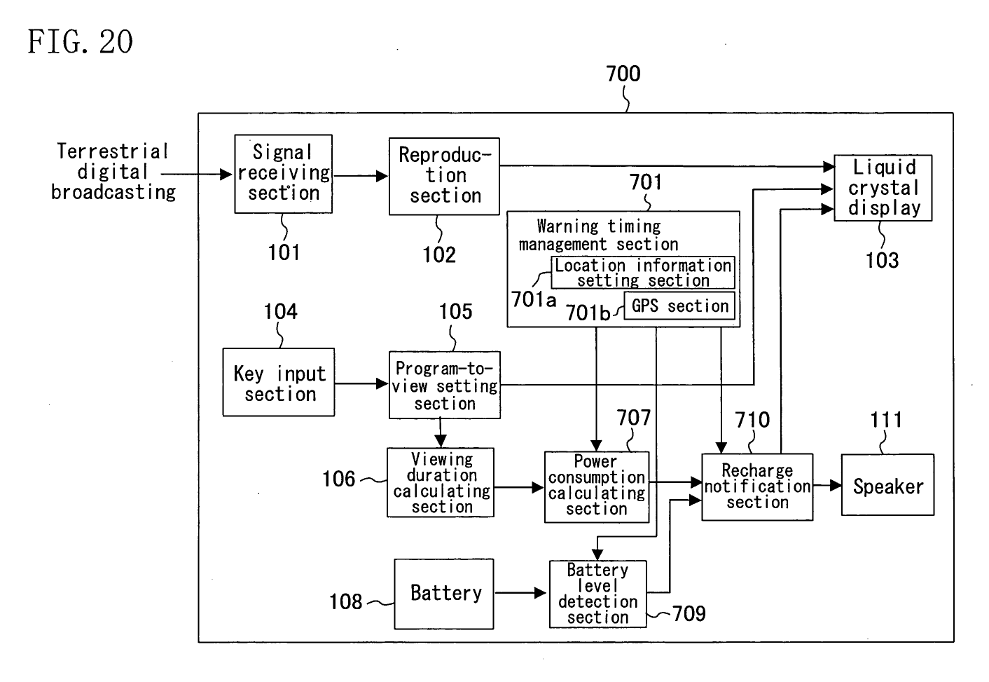

FIG. 20 is a block diagram showing a configuration of a television broadcast reception device 700 according to Embodiment 7 of the present invention. Referring to FIG. 20, the television broadcast reception device 700 is different from the television broadcast reception device 100 in that the television broadcast reception device 700 further includes a warning timing management section 701, a power consumption calculating section 707 is provided instead of the power consumption calculating section 107, a battery level detection section 709 is provided instead of the battery level detection section 109, and a recharge notification section 710 is provided instead of the recharge notification section 110.

The warning timing management section 701 includes a location information setting section 701a and a GPS (Global Positioning System) section 701b.

Information of a location where the user can recharge the battery (e.g., information of the location of the user's home) is set in the location information setting section 701a.

The GPS section 701b detects the current position information of the television broadcast reception device 700. When the detected position information matches position information set in the location information setting section 701a, the GPS section 701b outputs a position information match signal indicating that the detected position information matches the position information set in the location information setting section 701a.

The power consumption calculating section 707 calculates the amount of power to be consumed by the signal receiving section 101 and the reproduction section 102 operating over a period of the total viewing duration, when the GPS section 701b outputs the position information match signal.

The battery level detection section 709 detects the battery level of the battery 108 when the GPS section 701b outputs the position information match signal.

The recharge notification section 710 outputs a warning alarm from the speaker 111 and displays a warning message on the liquid crystal display 103 in order to notify the user that the battery needs to be recharged, if the amount of power to be consumed is greater than the battery level when the GPS section 701b outputs the position information match signal.

With the television broadcast reception device 700 having such a configuration, the amount of power needed is calculated in the power consumption calculating section 707 and the battery level is detected by the battery level detection section 709, when position information set in the location information setting section 701a matches the current position information of the television broadcast reception device 700 detected by the GPS section 701b. Then, when the amount of power to be consumed calculated by the power consumption calculating section 707 is greater than the battery level, the recharge notification section 710 notifies the user that the battery needs to be recharged via the liquid crystal display 103 or the speaker 111.

For example, when the recharge notification section 710 notifies the user that the battery needs to be recharged during the use of the television broadcast reception device, the user may be out at that point and therefore cannot recharge the battery, in which case the user needs to recharge the battery when the user comes home. However, the user may forget to recharge the battery by the time the user comes home, in which case the battery may run down inadvertently the user is viewing a program.

In contrast, with the television broadcast reception device 700, the user can set, in the location information setting section 701a, position information of the user's home. Then, the recharge notification section 710 notifies the user that the battery needs to be recharged when the user comes home. Thus, it is possible to prevent the user from forgetting to recharge the battery.

While an example where the position information of the user's home is set in the location information setting section 701a has been described above, any other location may be set as long as it is where the user can recharge the battery.

### Embodiment 8

This embodiment is an example of a device using a smart battery, or the like, that has a function of detecting the battery level of itself, wherein the battery level is obtained from the battery.

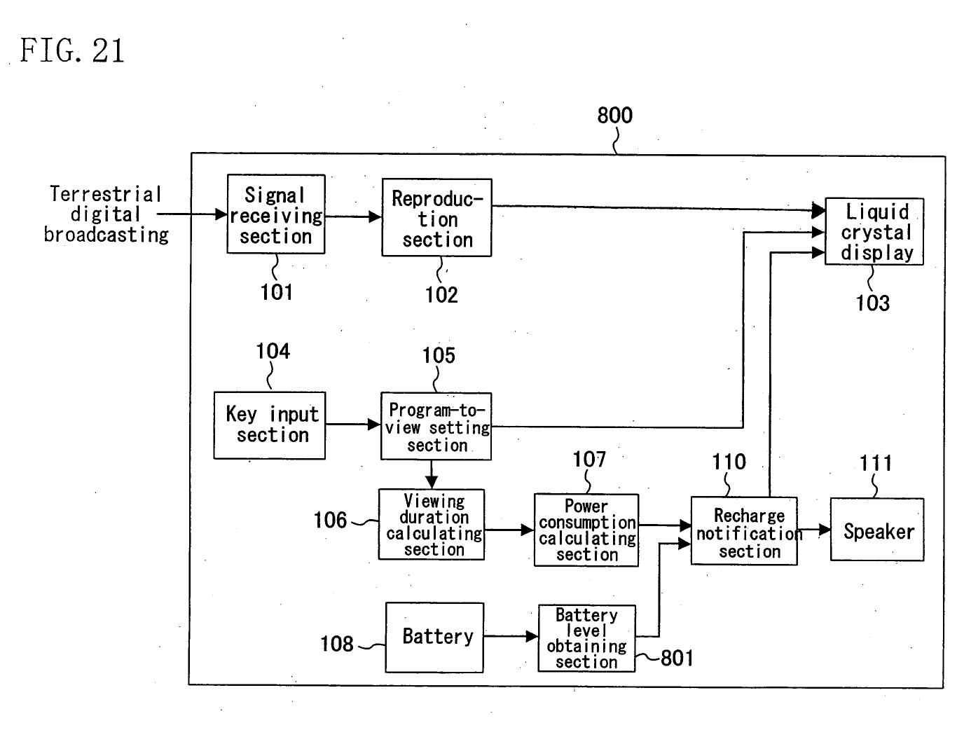

FIG. 21 is a block diagram showing a configuration of a television broadcast reception device 800 according to Embodiment 8 of the present invention. Referring to FIG. 21, the television broadcast reception device 800 is different from the television broadcast reception device 100 in that a battery level obtaining section 801 is provided instead of the battery level detection section 109 of the television broadcast reception device 100, and the battery 108 has a function of detecting the battery level of itself. The battery level obtaining section 801 obtains the battery level detected by the battery 108.

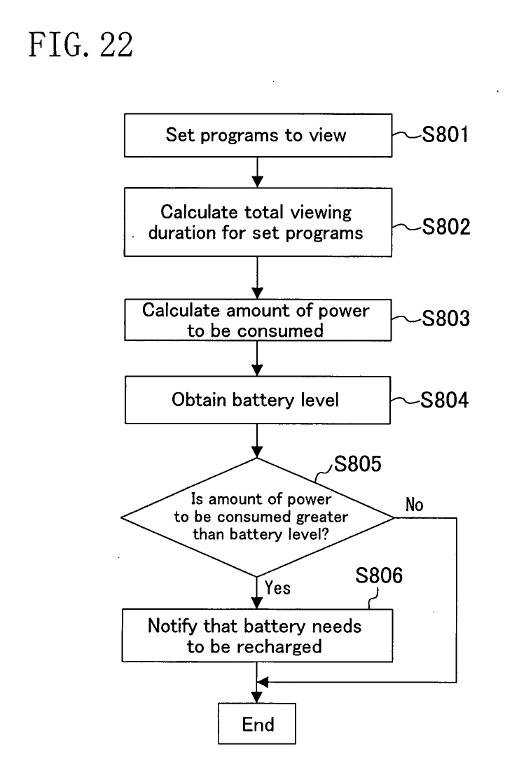

The television broadcast reception device 800 as described above performs the process shown in the flow chart of FIG. 22 to thereby prevent a situation where the battery runs down inadvertently while viewing a program. The process in each step will now be described.

Step S801

The user operates the key input section 104 to input program information of a program to view, such as the channel number, the starting time and the finishing time of the program, and the input program information is set in the program-to-view setting section 105. The program-to-view setting section 105 displays the set program information on the liquid crystal display 103, and outputs the program information to the viewing duration calculating section 106.

Step S802

The viewing duration calculating section 106 calculates the viewing duration for each program information by subtracting the starting time of the program information from the finishing time thereof, and also calculates the total viewing duration by adding together the viewing durations of all the selected programs.

Step S803

The power consumption calculating section 107 calculates the amount of power to be consumed by the signal receiving section 101 and the reproduction section 102 operating over a period of the total viewing duration, based on the total viewing duration calculated in the viewing duration calculating section 106.

Step S804

The battery level obtaining section 801 obtains the battery level from the battery 108.

Step S805

The recharge notification section 110 proceeds to step S806 when the amount of power to be consumed is greater than the battery level, and exits the process when the amount of power to be consumed is less than the battery level.

Step S806

The recharge notification section 110 notifies the user that the battery needs to be recharged.

As described above, according to the present embodiment, the amount of power to be consumed by the signal receiving section 101 and the reproduction section 102 is calculated based on the total viewing duration for programs set by the user as being programs to view. If the battery level is less than the calculated amount of power, the user is notified that the battery needs to be recharged. Therefore, it is possible to prevent a situation where the battery runs down inadvertently while viewing a program.

### Embodiment 9

This embodiment is an example of a device that can be programmed to record a program where it is possible to prevent a situation where the battery runs down inadvertently while recording a program.

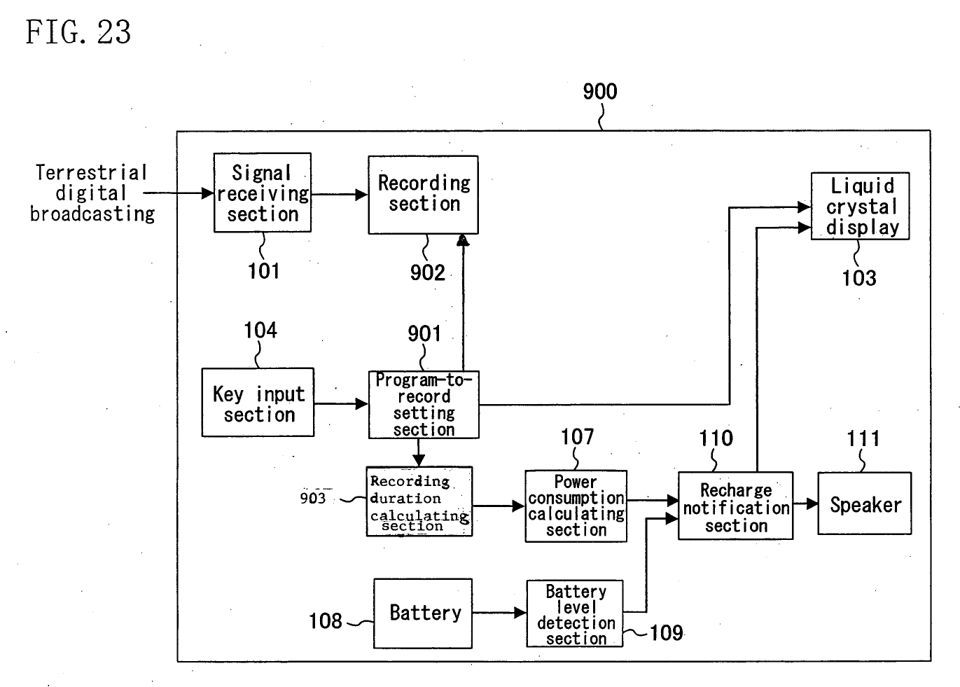

FIG. 23 is a block diagram showing a configuration of a television broadcast reception device 900 according to Embodiment 9 of the present invention. Referring to FIG. 23, the television broadcast reception device 900 includes a program-to-record setting section 901 replacing the program-to-view setting section 105 of the television broadcast reception device 100, a recording section 902 replacing the reproduction section 102, and a recording duration calculating section 903 replacing the viewing duration calculating section 106.

Program information, e.g., the channel number, the starting time and the finishing time, of the program specified by the user operating the key input section 104 are set (stored) in the program-to-record setting section 901.

At the starting time of a program set in the program-to-record setting section 901, the recording section 902 starts recording the program selected by the signal receiving section 101 (i.e., the program scheduled to be recorded).

The recording duration calculating section 903 calculates the recording duration for each program information stored in the program-to-record setting section 901 by subtracting the starting time of the program from the finishing time thereof, and also calculates the total recording duration by adding together the recording durations of all the selected programs.

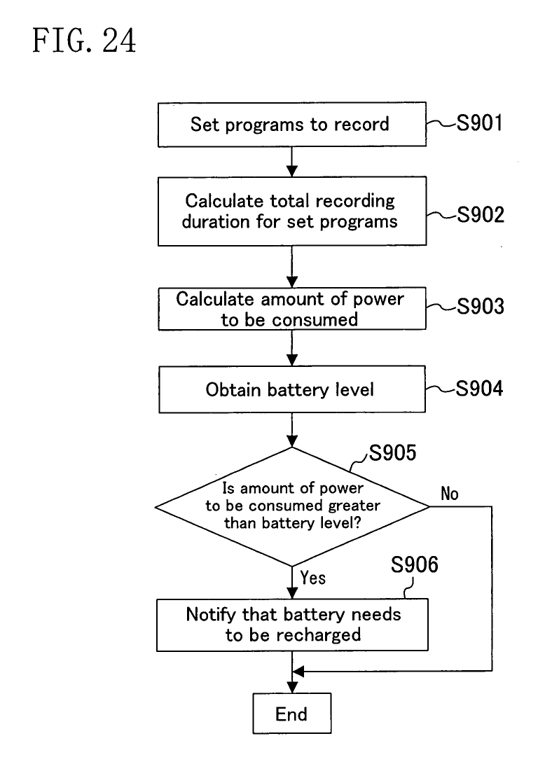

The television broadcast reception device 900 as described above performs the process shown in the flow chart of FIG. 24 to thereby prevent a situation where the battery runs down inadvertently while recording a program scheduled to be recorded. The process in each step will now be described.

Step S901

The user operates the key input section 104 to input program information of a program to record, such as the channel number, the starting time and the finishing time of the program, and the input program information is set in the program-to-record setting section 901. The program-to-record setting section 901 displays the set program information on the liquid crystal display 103, and outputs the program information to the recording duration calculating section 903.

Step S902

The recording duration calculating section 903 calculates the recording duration for each program information by subtracting the starting time of the program information from the finishing time thereof, and also calculates the total recording duration by adding together the recording durations of all the selected programs.

Step S903

The power consumption calculating section 107 calculates the amount of power to be consumed by the signal receiving section 101 and the recording section 902 operating over a period of the total recording duration, based on the total recording duration calculated in the recording duration calculating section 903.

Step S904

The battery level detection section 109 detects the battery level of the battery 108.

Step S905

The recharge notification section 110 proceeds to step S906 when the amount of power to be consumed is greater than the battery level, and exits the process when the amount of power to be consumed is less than the battery level.

Step S906

The recharge notification section 110 notifies the user that the battery needs to be recharged.

As described above, according to the present embodiment, the amount of power to be consumed by the signal receiving section 101 and the recording section 902 is calculated based on the total recording duration for programs set by the user as being programs to record. If the battery level is less than the calculated amount of power, the user is notified that the battery needs to be recharged. Therefore, it is possible to prevent a situation where the battery runs down inadvertently while recording a program.

In an alternative embodiment, the present invention may be implemented in the form of a device for controlling a television broadcast reception device, which does not include the signal receiving section 101, the reproduction section 102, the liquid crystal display 103 and the speaker 111. In such a case, the recharge notification section 110 does not have to have the output to the liquid crystal display 103 or the speaker 111, and may only include a section (i.e., a recharge determination section) for determining whether the amount of power to be consumed is greater than the battery level and for outputting the determination result to outside.

While the above embodiments are directed to examples where the television broadcast reception device receives terrestrial digital broadcasting signals, the embodiments are applicable to television broadcast reception devices for receiving terrestrial analog broadcasting signals, for example.

In addition to viewing TV programs where audio video data is received, the embodiments of the present invention are also applicable to devices for viewing data broadcasting programs where application programs and data are broadcast.

### INDUSTRIAL APPLICABILITY

The present invention is directed to a battery-powered television broadcast reception device, a device for controlling the television broadcast reception device, and a power management method for the television broadcast reception device, where it is possible to prevent a situation where the battery runs down inadvertently while viewing a program. Thus, the present invention is applicable to a battery-powered television broadcast reception device built in a mobile device such as a portable television or a mobile telephone, a device for controlling the television broadcast reception device, a power management method for the television broadcast reception device, etc.

1. A battery-powered television broadcast reception device, comprising:
a signal receiving section for receiving a television broadcasting signal;
a reproduction section for decoding and reproducing video data and audio data of a program included in the television broadcasting signal received by the signal receiving section;
a program-to-view setting section in which a plurality of program information are set, each program information including a starting time and a finishing time of a program to be viewed;
a viewing duration calculating section for calculating a viewing duration for each program information set in the program-to-view setting section by subtracting the starting time from the finishing time, and also calculating a total viewing duration by adding together the viewing durations of all program information set in the program-to-view setting section;
a power consumption calculating section for calculating a total amount of power to be consumed by the signal receiving section and the reproduction section operating over a period of the total viewing duration;
a battery level detection section for detecting a battery level of the battery; and
a recharge notification section for notifying a user that the battery needs to be recharged when the total amount of power to be consumed is greater than the battery level detected by the battery level detection section.

2. The television broadcast reception device of claim 1, wherein:
the television broadcasting signal is a signal including program information indicating a starting time and a finishing time of a program; and
the program-to-view setting section displays a list of the program information, and selected ones of the displayed program information are set in the program-to-view setting section.

3. The television broadcast reception device of claim 2, wherein:
the program information further includes information indicating a length of extension of each program; and
the viewing duration calculating section further adds the length of extension to a total of the viewing durations of all program information set in the program-to-view setting section to thereby obtain the total viewing duration.

4. The television broadcast reception device of claim 1, wherein:
the viewing duration calculating section calculates, for each program information set in the program-to-view setting section, an accumulative viewing duration by adding together the viewing duration of the subject program information and that of program information for a program whose starting time is earlier than that of the subject program information;
the power consumption calculating section calculates, as the total amount of power to be consumed, an amount of power to be consumed by the signal receiving section and the reproduction section operating over a period of the accumulative viewing duration; and
the recharge notification section notifies that programs cannot be viewed when the total amount of power to be consumed is greater than the battery level detected by the battery level detection section.

5. The television broadcast reception device of claim 1, further comprising a mobile telephone section powered by the battery, wherein the power consumption calculating section calculates, as the total amount of power to be consumed, a sum of an amount of power to be consumed by the signal receiving section and the reproduction section operating over a period of the total viewing duration and an amount of power to be consumed by the mobile telephone section operating in a stand-by mode from a present point in time until the finishing time of the program information for a program to be viewed set in the program-to-view setting section.

6. The television broadcast reception device of claim 1, further comprising:
a timer section for keeping a current time; and
a time setting section for setting time information representing a point in time specified by the user, wherein:
the power consumption calculating section calculates the total amount of power to be consumed when the current time kept by the timer section coincides with the time information set in the time setting section; and
the recharge notification section makes the notification when the current time kept by the timer section coincides with the time information set in the time setting section.

7. The television broadcast reception device of claim 1, further comprising:
a position information detection section for detecting current position information; and
a location information setting section for setting position information representing a position specified by the user, wherein:
the power consumption calculating section calculates the total amount of power to be consumed when the position information detected by the position information detection section coincides with the position information set in the location information setting section; and
the recharge notification section makes the notification when the position information detected by the position information detection section coincides with the position information set in the location information setting section.

8. A device for controlling a battery-powered television broadcast reception device, comprising:
a program-to-view setting section in which a plurality of program information are set, each program information including a starting time and a finishing time of a program to be viewed;
a viewing duration calculating section for calculating a viewing duration for each program information set in the program-to-view setting section by subtracting the starting time from the finishing time, and also calculating a total viewing duration by adding together the viewing durations of all program information set in the program-to-view setting section;
a power consumption calculating section for calculating a total amount of power to be consumed for viewing programs over a period of the total viewing duration;
a battery level detection section for detecting a battery level of the battery; and
a recharge determination section for determining that the battery needs to be recharged when the total amount of power to be consumed is greater than the battery level obtained by the battery level obtaining section.

9. The device for controlling a television broadcast reception device of claim 8, wherein:
the viewing duration calculating section calculates, for each program information set in the program-to-view setting section, an accumulative viewing duration by adding together the viewing duration of the subject program information and that of program information for a program whose starting time is earlier than that of the subject program information;
the power consumption calculating section calculates, as the total amount of power to be consumed, an amount of power to be consumed for viewing programs over a period of the accumulative viewing duration; and
the recharge determination section determines that the programs cannot be viewed when the total amount of power to be consumed is greater than the battery level detected by the battery level detection section.

10. The television broadcast reception device of claim 1, wherein:
the battery has a function of detecting a battery level; and
a battery level obtaining section for obtaining the battery level from the battery is provided instead of the battery level detection section.

11. A battery-powered television broadcast reception device, comprising:
a signal receiving section for receiving a television broadcasting signal;
a recording section for recording video data and audio data of a program included in the television broadcasting signal received by the signal receiving section;
a program-to-record setting section in which a plurality of program information are set, each program information including a starting time and a finishing time of a program to be recorded;
a recording duration calculating section for calculating a recording duration for each program information set in the program-to-record setting section by subtracting the starting time from the finishing time, and also calculating a total recording duration by adding together the recording durations of all program information set in the program-to-record setting section;
a power consumption calculating section for calculating a total amount of power to be consumed by the signal receiving section and the recording section operating over a period of the total recording duration;
a battery level detection section for detecting a battery level of the battery; and
a recharge notification section for notifying the user that the battery needs to be recharged when the total amount of power to be consumed is greater than the battery level detected by the battery level detection section.

12. A power management method for a battery-powered television broadcast reception device, the television broadcast reception device comprising:
a signal receiving section for receiving a television broadcasting signal;
a reproduction section for decoding and reproducing video data and audio data of a program included in the television broadcasting signal received by the signal receiving section; and
a program-to-view setting section in which a plurality of program information are set, each program information including a starting time and a finishing time of a program to be viewed, the method comprising:
a viewing duration calculating step of calculating, for each program information set in the program-to-view setting section, a viewing duration by subtracting the starting time from the finishing time, and also calculating a total viewing duration by adding together the viewing durations of all program information set in the program-to-view setting section;
a power consumption calculating step of calculating a total amount of power to be consumed by the signal receiving section and the reproduction section operating over a period of the total viewing duration;
a battery level detection step of detecting a battery level of the battery; and
a recharge notification step of notifying a user that the battery needs to be recharged when the total amount of power to be consumed is greater than the battery level detected by the battery level detection step.

13. The power management method for a television broadcast reception device of claim 12, wherein:
the television broadcasting signal is a signal including program information indicating a starting time and a finishing time of a program, the method further comprising:
a program information obtaining step of obtaining the program information from the television broadcasting signal received by the signal receiving section;
an electronic program guide displaying step of displaying a list of the program information; and
a program information selecting step of setting, in the program-to-view setting section, selected ones of the program information displayed by the electronic program guide displaying step.

14. The power management method for a television broadcast reception device of claim 13, wherein:
the program information further includes information indicating a length of extension of each program; and
the viewing duration calculating step further adds the length of extension to a total of the viewing durations of all program information set in the program-to-view setting section to thereby obtain the total viewing duration.

15. The power management method for a television broadcast reception device of claim 12, wherein:
the viewing duration calculating step calculates, for each program information set in the program-to-view setting section, an accumulative viewing duration by adding together the viewing duration of the subject program information and that of program information for a program whose starting time is earlier than that of the subject program information;
the power consumption calculating step calculates, as the total amount of power to be consumed, an amount of power to be consumed by the signal receiving section and the reproduction section operating over a period of the accumulative viewing duration; and
the recharge notification step notifies that programs cannot be viewed when the total amount of power to be consumed is greater than the battery level detected in the battery level detection step.

16. The power management method for a television broadcast reception device of claim 12, wherein:
the television broadcast reception device further comprises a mobile telephone section powered by the battery; and
the power consumption calculating step calculates, as the total amount of power to be consumed, a sum of an amount of power to be consumed by the signal receiving section and the reproduction section operating over a period of the total viewing duration and an amount of power to be consumed by the mobile telephone section operating in a stand-by mode from a present point in time until the finishing time of the program information for a last program to be viewed set in the program-to-view setting section.

17. The power management method for a television broadcast reception device of claim 12, the television broadcast reception device further comprising:
a timer section for keeping a current time; and
a time setting section for setting time information representing a point in time specified by the user, wherein:
the power consumption calculating step calculates the total amount of power to be consumed when the current time kept by the timer section coincides with the time information set in the time setting section; and
the recharge notification step makes the notification when the current time kept by the timer section coincides with the time information set in the time setting section.

18. The power management method for a television broadcast reception device of claim 12, the television broadcast reception device further comprising:
a position information detection section for detecting current position information; and
a location information setting section for setting position information representing a position specified by the user, wherein:
the power consumption calculating step calculates the total amount of power to be consumed when the position information detected by the position information detection section coincides with the position information set in the location information setting section; and
the recharge notification step makes the notification when the position information detected by the position information detection section coincides with the position information set in the location information setting section.
